(19) United States
(12) Patent Application Publication
(10) Pub. No.: US 2017/0047804 A1
(43) Pub. Date: Feb. 16, 2017

(54) ELECTRIC MACHINE

(71) Applicant: FEAAM GmbH, Neubiberg (DE)

(72) Inventor: Gurakuq DAJAKU, Neubiberg (DE)

(21) Appl. No.: 15/306,052

(22) PCT Filed: Apr. 21, 2015
(86) PCT No.: PCT/EP2015/058610

§ 371 Date: Oct. 21, 2016

(30) Foreign Application Priority Data
Apr. 22, 2014 (DE) 102014105642.6

(51) Int. Cl. H02K 3/12; H02K 3/47; H02K 3/28

(52) U.S. Cl. CPC H02K 3/12; H02K 3/28; H02K 3/47; H02K 2203/09

(57) ABSTRACT

The present invention provides an electric machine with a stator (1) and a rotor (21) mounted movable relative to the stator, wherein the stator comprises a plurality of slots (2) for receiving a stator winding. Exactly one conductor portion (3) of the stator winding is inserted into each slot. The conductor portions (3) are short-circuited with one another in a short-circuiting element on a first side (5) of the stator and are integrally formed with said short-circuiting element. On a second side (6) of the stator, the conductor portions (3) are connected to in each case one terminal of a power supply unit (8) which supplies adequate phase currents.

The present invention relates to an electric machine with a stator and a rotor mounted movable relative to said stator.

Electric machines can be operated as a motor or a generator. The stator comprises electric windings, which are connected to a power system, which often has multiple phases.

Distributed windings are often used for applications with more than two coils per pole per phase.

Although these distributed windings come with several drawbacks, e.g. overlapping coils involving higher manufacturing effort and higher material costs, they are being employed in electric machines by many manufacturers to this day. The main advantage of the distributed winding lies with the fact that the magnetomotive force in the air gap between the stator and the rotor of the machine has a low component of harmonics, i.e. a low component of undesired harmonics of the magnetomotive force. This results in a high performance of the machine, which includes minor rotor losses, a low noise level, few vibration problems and so on.

Another disadvantage of the distributed winding lies with the elaborate winding head. Long wires are required in the winding head to connect the conductor portions inserted into the slots of the stator, since in each case distances need to be bridged across a plurality of stator teeth.

Therefore, there is a demand for an electric machine which can be produced with little effort while having good electrical properties, such as a low noise level.

The object is achieved by the subject-matter of patent claim 1. Advantageous embodiments and developments are indicated in the dependent claims.

According to the proposed principle, a stator is provided, which comprises a plurality of slots for receiving one or multiple stator windings. In each case one conductor portion of the stator winding is inserted into the slots, wherein the conductor portions are electrically connected to one another on one end, i.e. on one side of the stator, so that they produce a short-circuit with one another. The respective free ends of the conductor portions are connected to one terminal of the power supply unit, respectively, on the side of the stator—in the case of a radial flux-type electric machine—lying oppositely in the axial direction. As a result, the conductor portions can be controlled individually or in groups, which will later be explained in greater detail.

Thereby it is possible to supply each conductor portion with an individual phase of the electric signal of the power supply unit.

Short-circuiting the conductor portions on one side of the stator can be achieved with little effort. A short-circuiting element is provided to that end, which is integrally formed with the conductor portions. The short-circuiting element and the conductor portions can be integrally formed from copper or aluminum or bronze, for example.

The short-circuiting element is preferably designed as a short-circuit ring. The short-circuit ring may have a rectangular cross-section.

The proposed machine dispenses with distributed windings. The manufacturing effort is low since in each case one conductor portion, which may be straight, for example, can be inserted in the slots.

On the whole, the proposed machine combines good electric and mechanic properties, such as a low noise level, minor rotor losses and low vibrations with the advantage of a particularly simply production, which dispenses with distributed windings and which is cost-efficient as a result.

In one embodiment, the machine comprises multiple pole pairs, wherein the conductor portions, which are short-circuited with one another on the first side of the stator, are assigned to a first pole pair. Further conductor portions are assigned to another pole pair and short-circuited with one another in another short-circuiting element on a second side of the stator. On the first side of the stator, there further conductor portions are each connected to one terminal of the power supply unit or another power supply unit.

The further short-circuiting elements and the short-circuited conductor portions are preferably integrally formed.

The power supply unit is in each case designed and connected to the conductor portions in such a way that the conductor portions are either individually supplied each with an individual electric phase or respective groups of neighboring conductor portions are formed. The conductor portions of one and the same group are commonly controlled with the same electric phase, wherein each group is controlled individually with an individual phase.

Preferably, the electric machine comprises multiple phases, which are provided by the power supply unit. In one embodiment, the number of phases is at least three.

In one embodiment, the number of phases is at least four.

In one embodiment, the number of phases is at least five.

In one embodiment, the number of phases is at least ten.

Due to the fact that the power supply unit individually supplies the conductor portions with a phase current, the proposed principle is particularly well suited for a plurality of phases.

In one embodiment, the conductor portions inserted into the slots have a straight design. As a result, both the production of the slot and the production of the conductor portion is simplified once again.

The respective conductor portions inserted into the slots may be aluminum rods, copper rods or rods made of a conductor having a poorer conductivity than aluminum or copper, such as bronze, for example.

A short-circuit ring may be provided for short-circuiting the conductor portions of the side of the stator which is provided for the short-circuit, for example. This achieves a particularly simple and cost-efficient realization of the short-circuit connection of the conductor portions on one side of the stator.

In one embodiment, the power supply unit is set-up to change the pole pair number of the machine during operation. Hereby the machines may be optimized, for example, for different operating states. In this case, the pole pair number may be different during the start-up of the machine than at a higher (rotational) speed.

In one embodiment, the power supply unit is set-up to deactivate at least one conductor portion during operation. This may be effected, for example, by an interruption of the electrical connection between the respective connection of the power supply unit and the assigned conductor portion. This can be effected during partial load operation, for example.

In one embodiment, the power supply unit comprises a commutation element. As a result, multiple different electrical phases are generated during the rotation of the rotor. Said different electrical phases can be used for feeding current into the conductor portions of the stator.

The conductor portions inserted into the slots can be integrally formed. As an alternative, the conductor portions may each comprise multiple conductor sub-portions which are connected in parallel.

As a result, the proximity effect and/or the skin effect can be reduced.

Iron bridges can be inserted between the conductor sub-portions in order to increase the leakage inductance of the slots.

In one embodiment, the power supply unit comprises one or multiple direct voltage sources, which are connected to the conductor portions via electronic switches in a switchable manner. For example, a distinct direct voltage source may be provided for each conductor portion. Said multiple direct voltage sources may have the same design or may have a different design.

Experiments have shown that the proposed machine requires a power supply unit with a greater number of switch elements than a conventional machine with a distributed winding, but that this additional effort is more than compensated by the savings that result from the omission of distributed windings and by requiring less block voltage of the switch elements. All in all, the production effort is significantly lower than in a conventional machine with a distributed winding.

The short-circuiting element and, if applicable, the present further short-circuiting element may comprise cooling fins. Said cooling fins improve heat dissipation.

The cooling fins may be mounted in the axial direction and/or in the radial direction on the outside of the short-circuiting element and/or in the radial direction on the inside of said short-circuiting element.

As an alternative or in addition, the cooling fins may run in a curved fashion in a circumferential direction and/or in a radial direction and/or in a diametrical direction.

The cooling fins may be integrally formed with the short-circuiting element and the conductor portions connected thereto.

Said integral design may include a (high pressure) casting method, a casting method or a beam melting method. The latter is also known as 3D printing.

The invention will now be explained in greater detail by means of several exemplary embodiments with reference to the drawings.

The drawings show in:

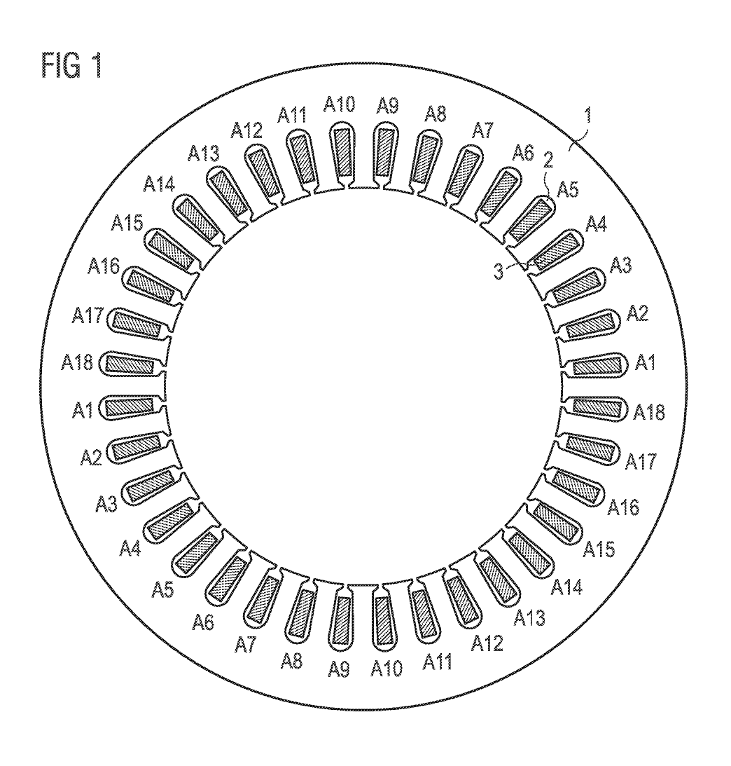

FIG. 1 an exemplary embodiment of a stator according to the proposed principle for a four-pole electric machine,

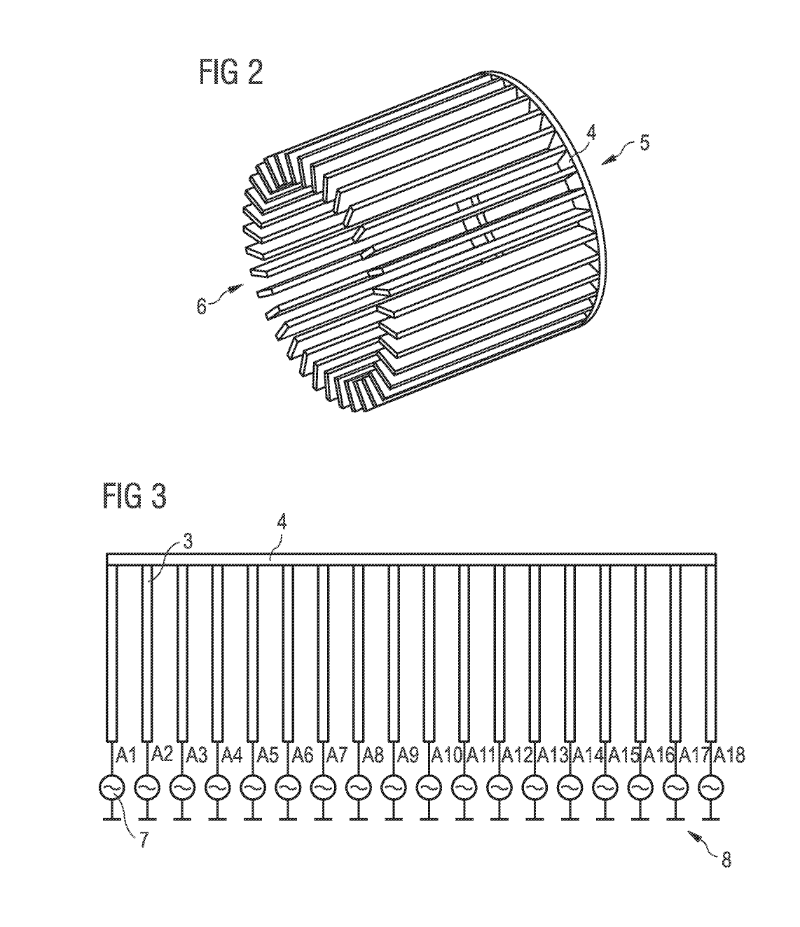

FIG. 2 an exemplary winding structure for the exemplary embodiment of FIG. 1,

FIG. 3 an exemplary, eighteen-phase power supply unit for controlling a pole pair of the stator winding of the exemplary embodiment of FIG. 1,

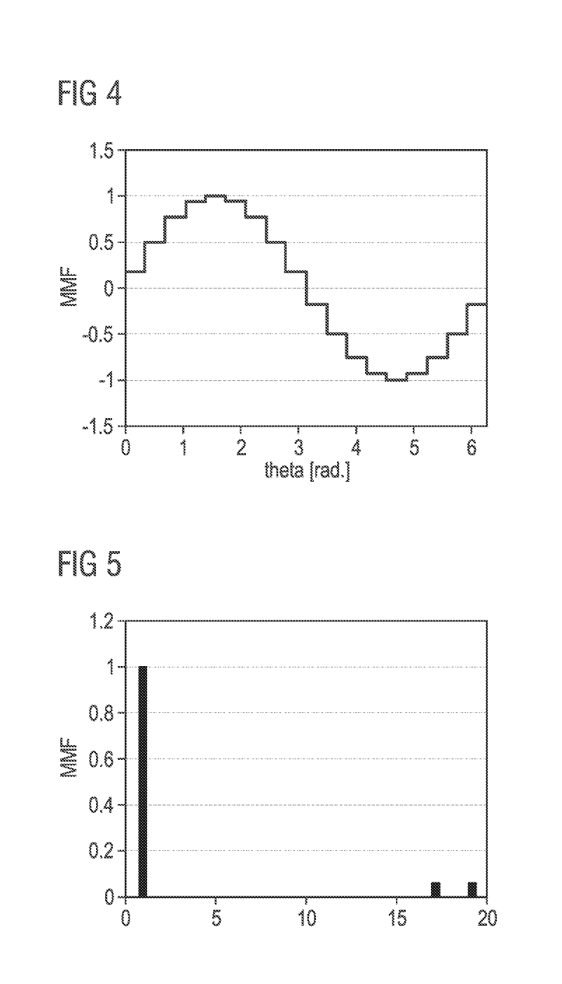

FIG. 4 the electromotive force plotted against the electric angle of the machine of FIG. 1 by means of an exemplary diagram,

FIG. 5 the illustration of the harmonic of the magnetomotive force for the example of FIG. 1,

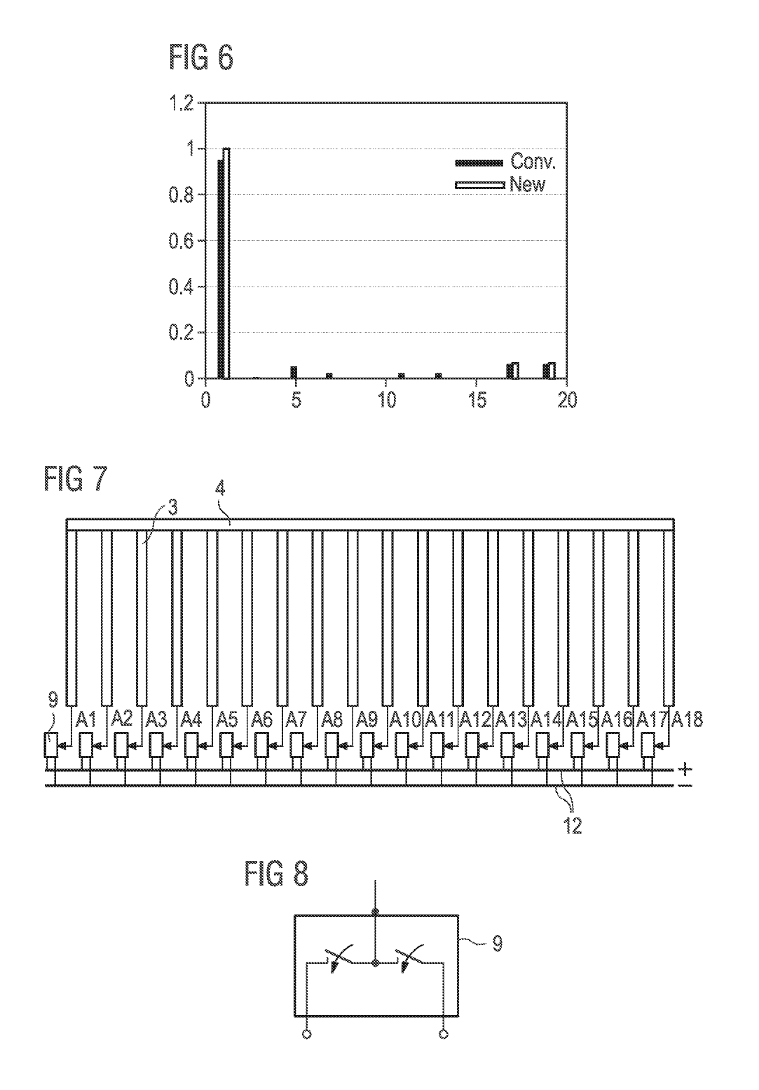

FIG. 6 a comparison of the harmonic of the magnetomotive force between the embodiment according to FIG. 1 on the one hand, and on the other hand a conventional distributed winding,

FIG. 7 an exemplary embodiment of the control of the conductor portions of FIG. 1 with a multiphase inverter,

FIG. 8 an exemplary embodiment of a bipolar switch for use in the circuit of FIG. 7,

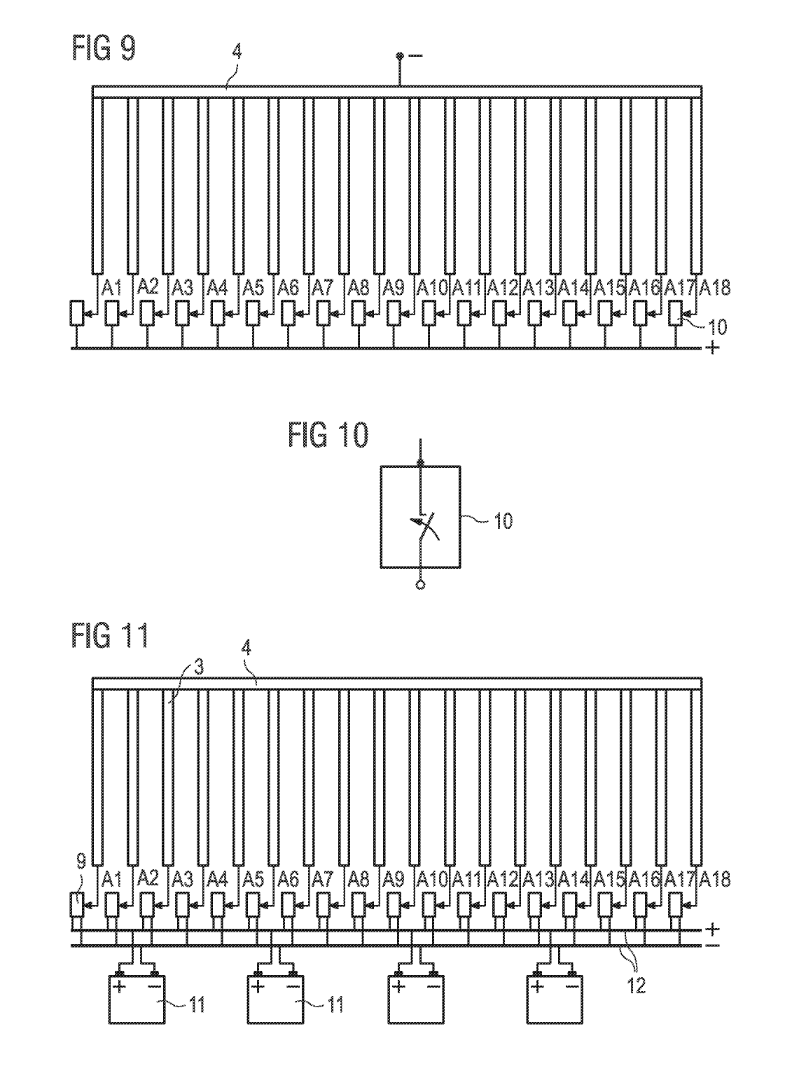

FIG. 9 an alternative exemplary embodiment of a power supply unit for the control of the conductor portions,

FIG. 10 an exemplary embodiment of a unipolar switch for use in the power supply unit according to FIG. 9,

FIG. 11 another embodiment of the power supply unit with multiple direct voltage sources,

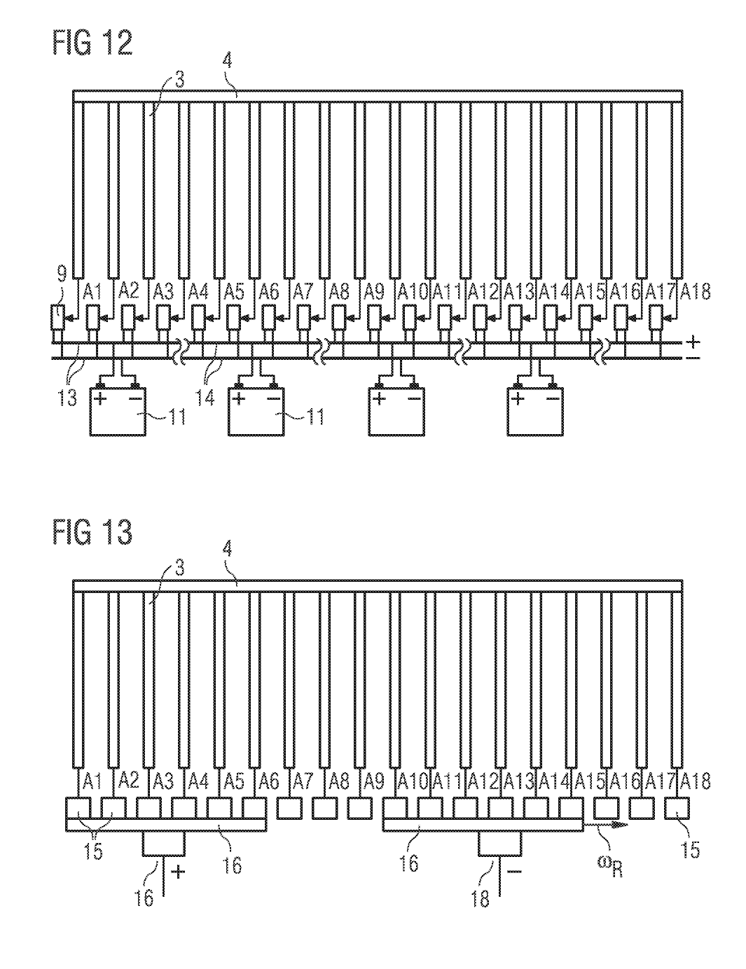

FIG. 12 another embodiment of the power supply unit with multiple direct voltage sources,

FIG. 13 an exemplary embodiment of the power supply unit with rotating brushes,

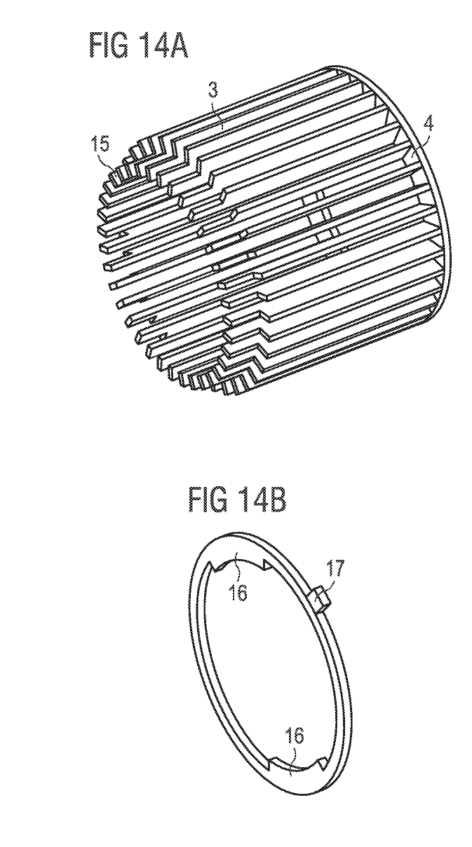

FIG. 14A an exemplary embodiment of the stator winding adapted for a commutation,

FIG. 14B an exemplary rotating carbon brush ring for use in the stator winding of FIG. 14A,

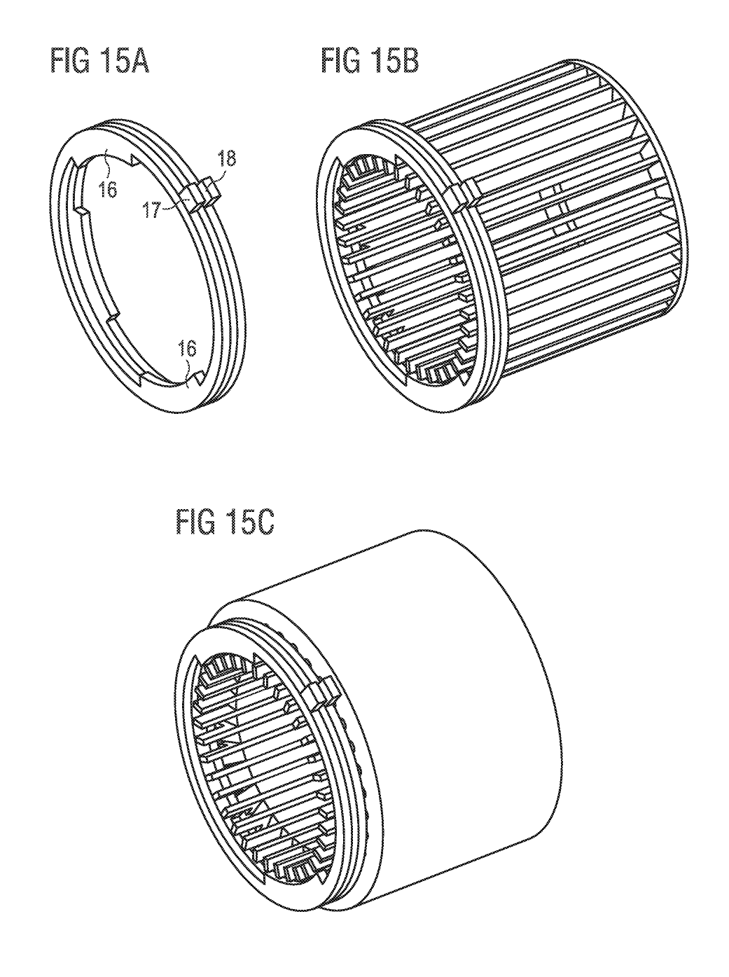

FIG. 15A another exemplary embodiment of a rotating carbon brush ring system,

FIG. 15B an exemplary winding that fits to the embodiment of FIG. 15A,

FIG. 15C an exemplary embodiment which combines the components of FIGS. 15A and 15B,

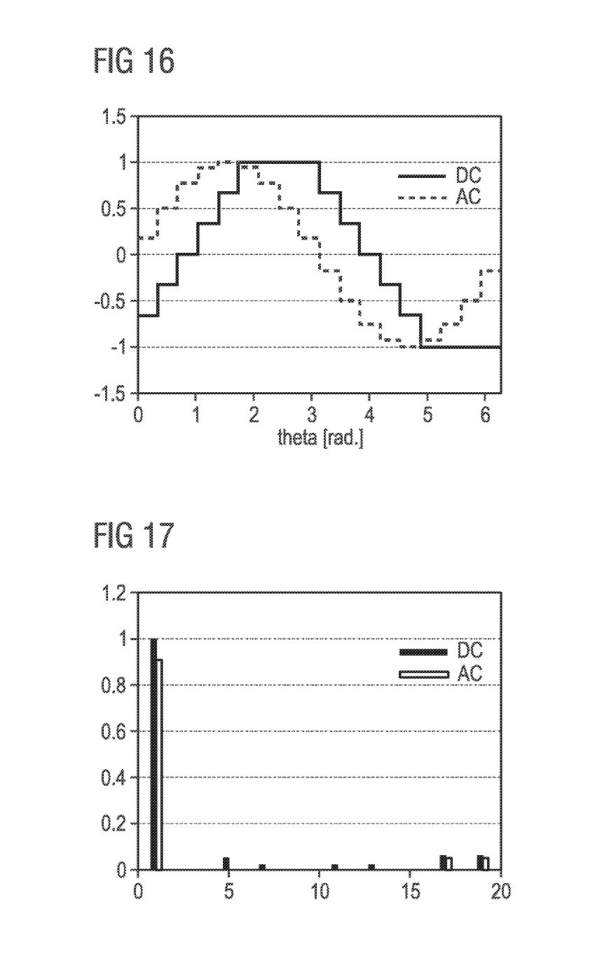

FIG. 16 a comparison of the magnetomotive force between direct current supply and alternating current supply, plotted against the rotary angle,

FIG. 17 a comparison of the harmonic of the magnetomotive force between a direct current supply and an alternating current supply,

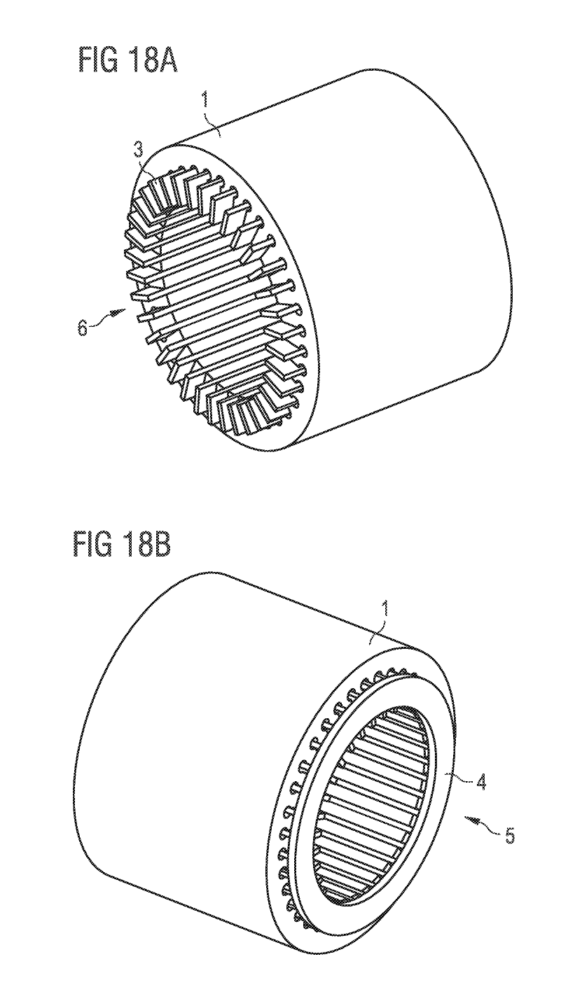

FIG. 18A an exemplary embodiment of the stator with inserted stator winding in a perspective view of a first side of the stator,

FIG. 18B a second side of the stator of FIG. 18A,

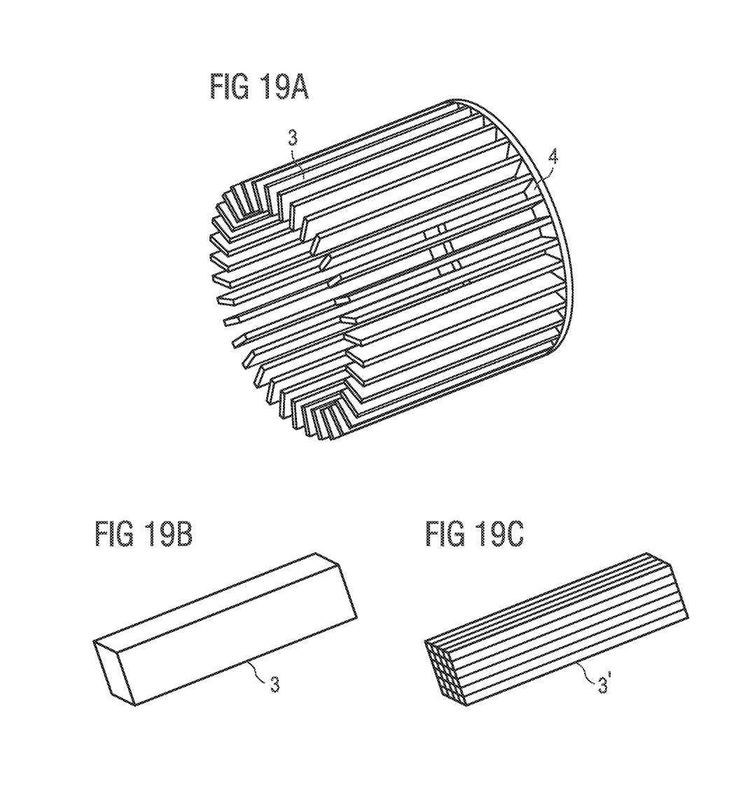

FIG. 19A an exemplary design of the stator winding,

FIG. 19B an exemplary, solid conductor portion for use in the stator winding of FIG. 19A,

FIG. 19C an exemplary, sheeted conductor portion for use in the stator winding of FIG. 19A,

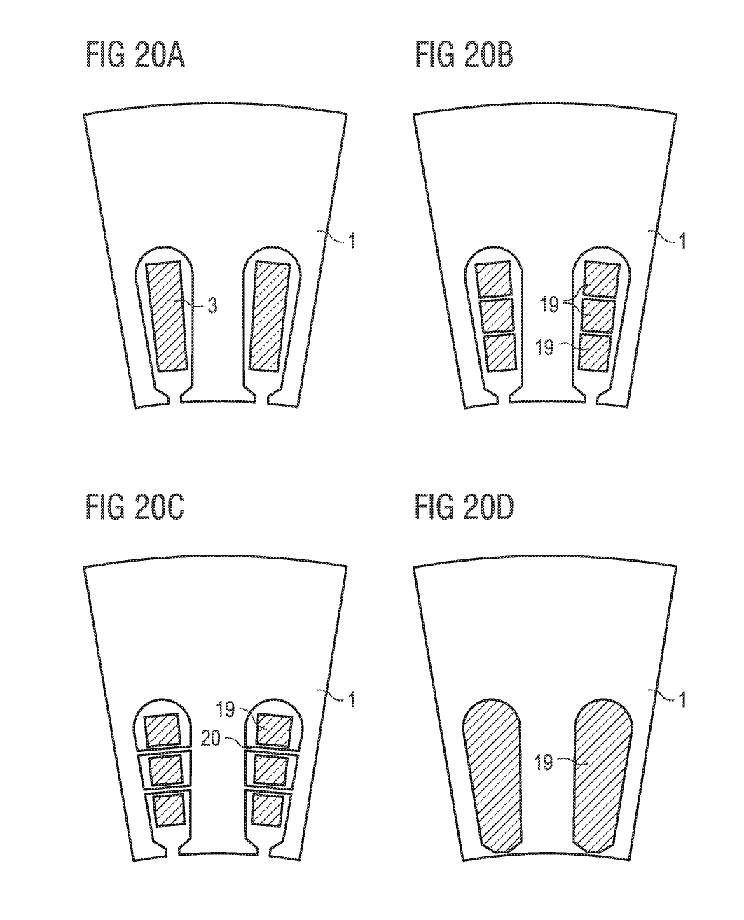

FIG. 20A a section of the stator with conductor portions,

FIG. 20B a design of the stator with conductor sub-portions connected in parallel by means of an exemplary sectional view,

FIG. 20C an exemplary embodiment of a section of the stator with iron bridges,

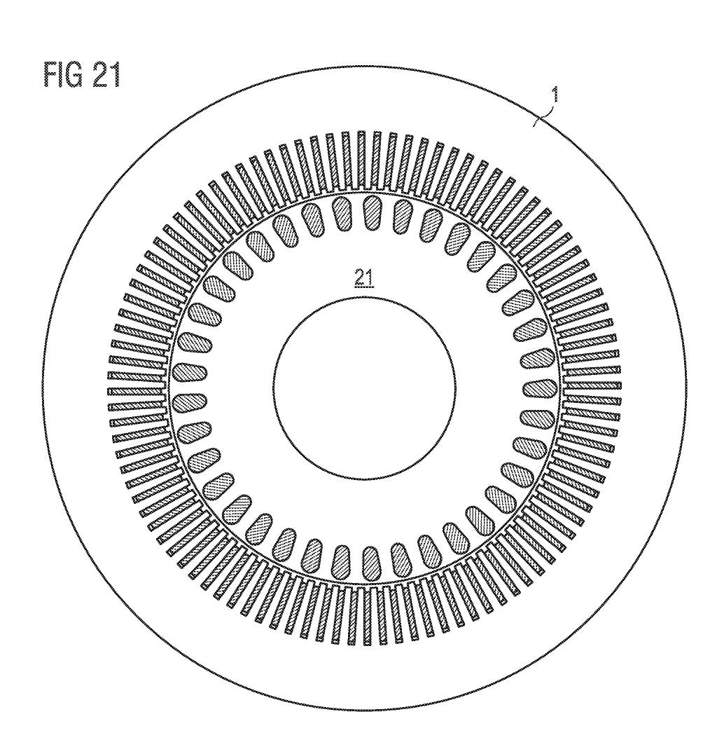

FIG. 21 an exemplary embodiment of the stator winding according to the proposed principle with 100 phases in a four-pole machine,

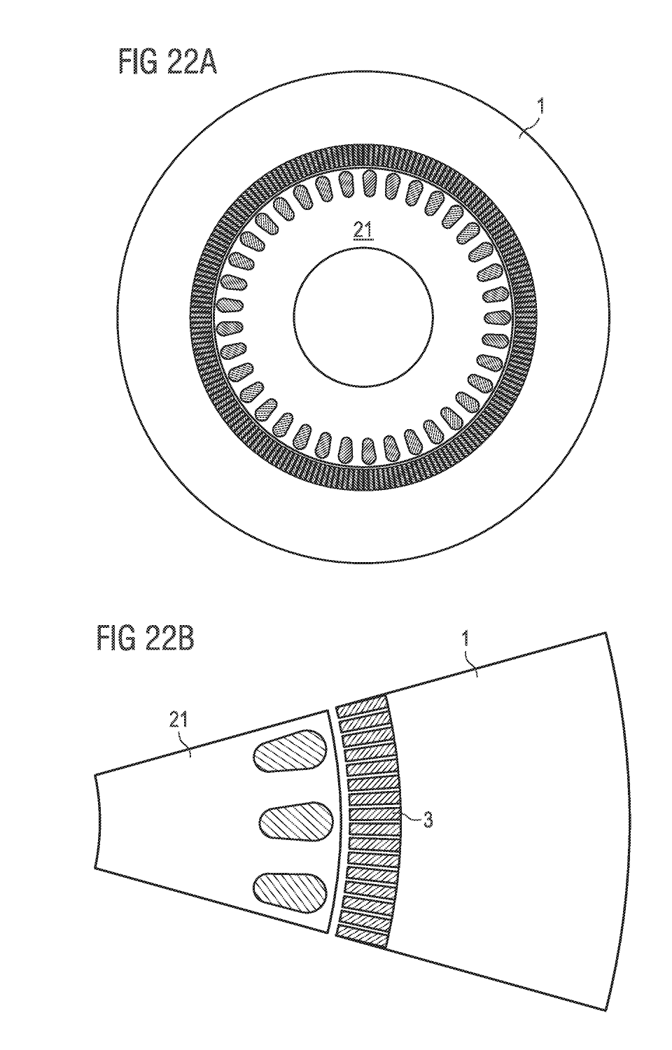

FIG. 22A an embodiment of a machine without slots and without teeth,

FIG. 22B an enlarged sectional view of FIG. 22A,

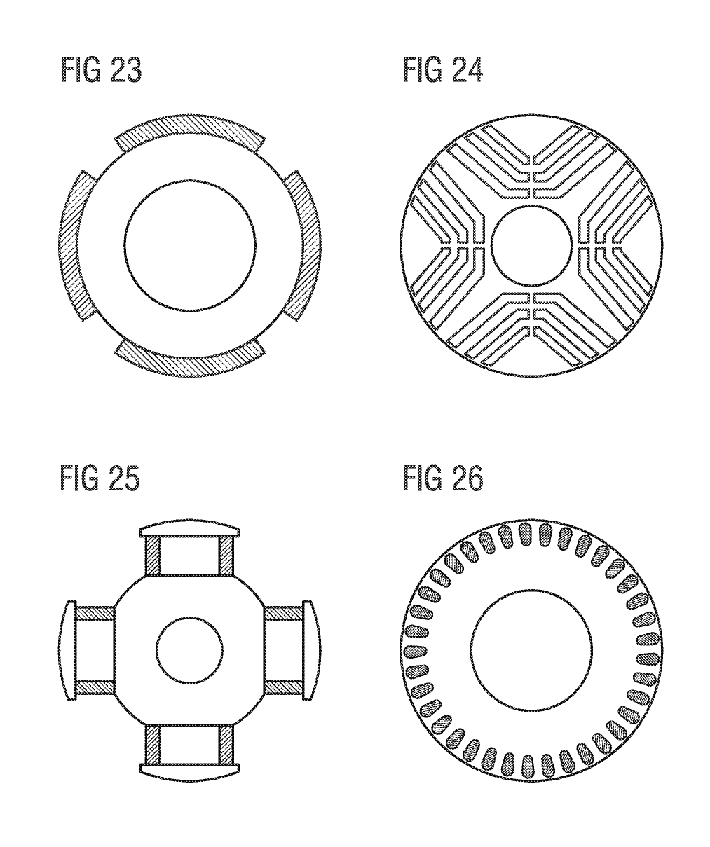

FIG. 23 an exemplary embodiment of the rotor as a permanent magnet rotor,

FIG. 24 an exemplary embodiment of the rotor as a reluctance rotor,

FIG. 25 an exemplary embodiment of the rotor as a current-excited rotor,

FIG. 26 an exemplary embodiment of the rotor as asynchronous rotor,

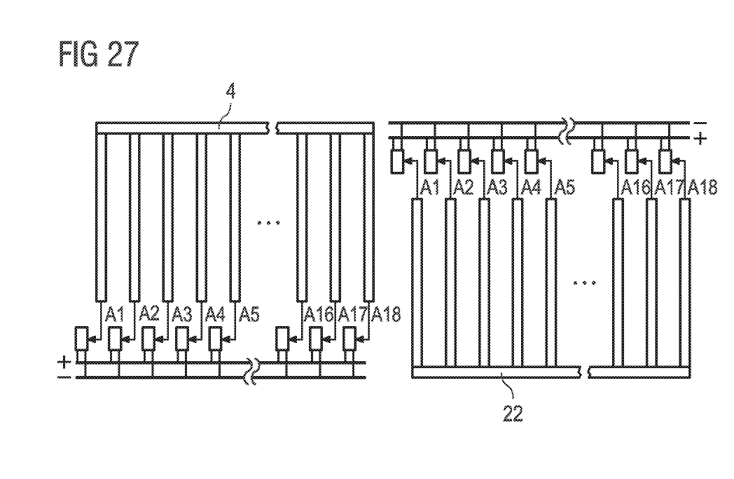

FIG. 27 an exemplary embodiment of the stator winding with multiple pole pairs and an opposite short-circuit ring,

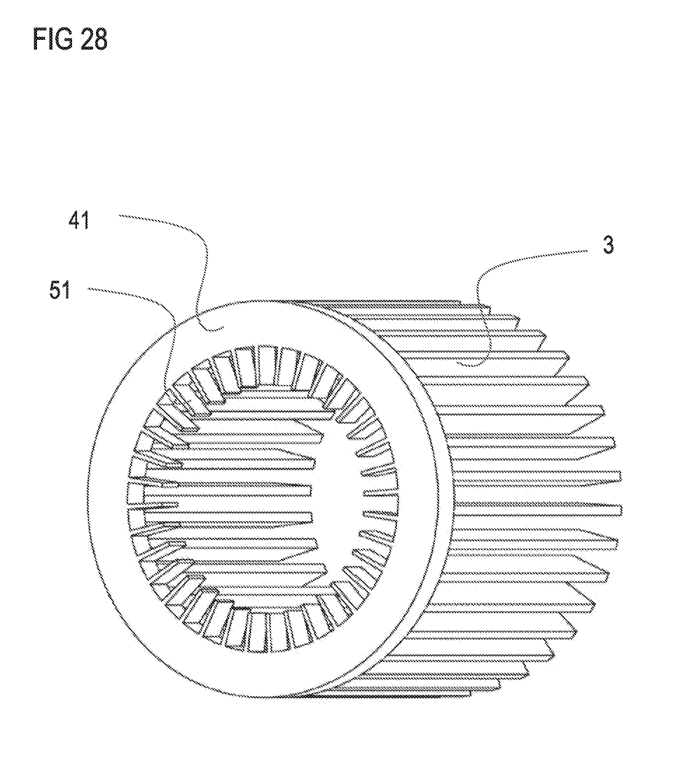

FIG. 28 a first exemplary embodiment of a short-circuit ring with cooling fins,

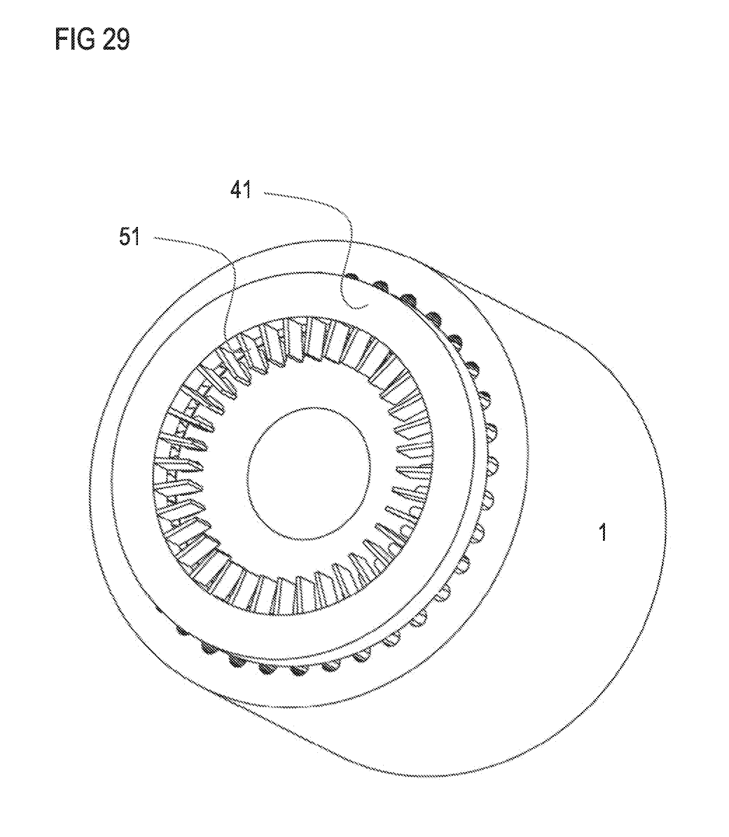

FIG. 29 the exemplary embodiment of FIG. 29 with a stator,

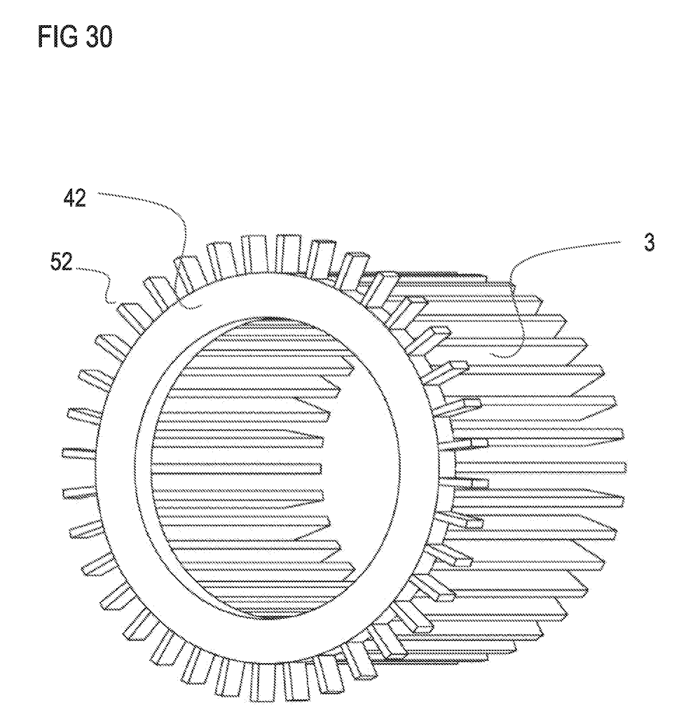

FIG. 30 a second exemplary embodiment of a short-circuit ring with cooling fins,

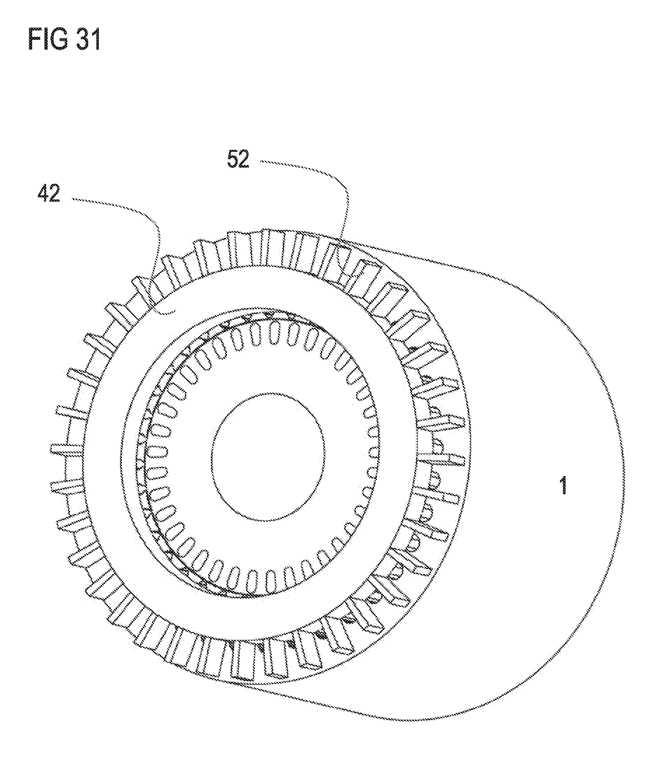

FIG. 31 the exemplary embodiment of FIG. 30 with a stator,

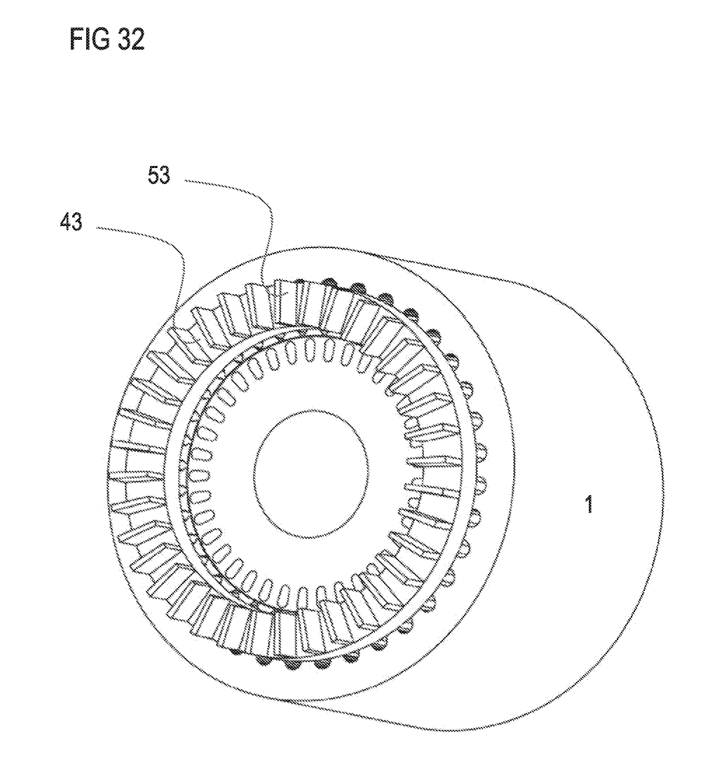

FIG. 32 a third exemplary embodiment of a short-circuit ring with cooling fins, and

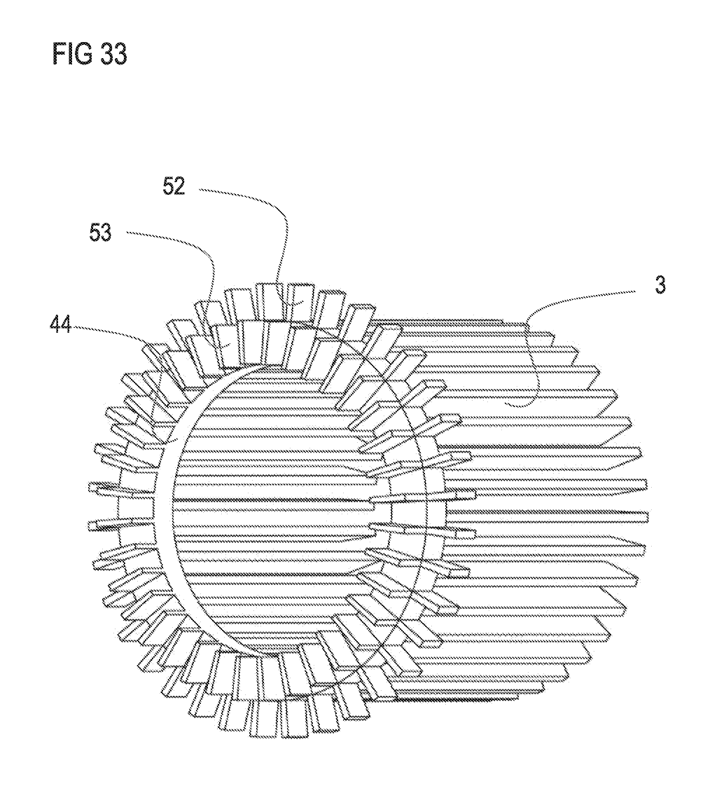

FIG. 33 a fourth exemplary embodiment of a short-circuit ring with cooling fins.

FIG. 1 shows a first exemplary embodiment of a stator 1 of an electric machine, which is designed as a rotating machine with an inner rotor, in a cross-sectional view. The rotor is not shown in FIG. 1 for the sake of clarity. The machine comprises slots 2 extending in the axial direction on the inner side of the stator along the periphery, which are shown in a cross-section here. In each case one conductor portion 3 of a stator winding is inserted into the slots 2, which will be described in greater detail later in regards to FIG. 2. Exactly one conductor portion 3 is arranged in each slot 2. The winding comprises eighteen phases. The phases of the winding are referred to as A1, A2, . . . , A18. The machine has a four-pole machine design and thus comprises the pole number 2. As a result, each phase A1 to A18 is present twice, wherein the corresponding conductor portions are offset at 180 degrees to one another.

The current of a conductor portion ik in each phase can be described according to the following formula:

$${i}_{k} = \hat{I} \cdot cos ( ω t - p \cdot ( k - 1 ) \frac{2 π}{m}$$

with Qs=p·m and K=1, . . . , Qs

Here, k is the number of the conductor portion, m is the total number of phases, p is the number of the pole pairs and Qs is the total number of stator slots. Accordingly, the phase voltage is:

$${u}_{k} = \hat{U} \cdot sin ( ω t - p \cdot ( k - 1 ) \frac{2 π}{m} + {ϕ}_{u , k}$$

As shown in FIG. 2, all conductor portions 3 are connected to one another with a short-circuit ring 4 at one end. The short-circuit ring 4 is arranged at a first side of the stator 5. On an opposite side 6 of the stator, the free ends of the conductor portions 3 are connected to one terminal of a power supply unit, respectively, however this is not illustrated in FIG. 2.

The short-circuit ring 4 is illustrated on the upper edge in FIG. 3. The conductor portions 3 are in each case connected to one electric current source 7 of a power supply unit 8 on the free ends of said portions 3. Operation of the power supply unit will later be described in greater detail.

FIG. 4 shows the distribution of the magnetomotive force MMK plotted against the electric angle from 0 to 2 Pi for the exemplary electric machine, according to FIGS. 1 to 3.

As can be taken from FIG. 5, which shows the harmonics of the magnetomotive force of the machine according to FIGS. 1 to 3, the magnetomotive force does not actually have any significant harmonics beyond the fundamental wave which is used an operating wave.

FIG. 6 shows a comparison of the harmonic of the magnetomotive force between the configuration according to FIG. 1 on the one hand, and on the other hand a conventional distributed winding. It can be discerned that the conventional distributed winding comprises even more undesired harmonics than the machine, according to the proposed principle.

Furthermore, the propose machine has a higher power density. A comparison of the machines was conducted under the same conditions, i.e. the number of stator slots and the number of conductor portions per slot was assumed to be equal for both machines.

The winding factor of the machine from FIG. 1 is 1. It is 0.96 in the conventional machine with distributed winding. As a result, power density of the machine, according to the proposed principle, is 4% greater for the example shown.

With regard to the following Figures, the multiphase supply of the electric machine in the power supply unit is described by means of several examples. It is true for all of the following exemplary embodiments according to FIGS. 7 to 12 that modern semiconductor switches, such as MOSFETs or IGBTs, can be used. Said electronic switches convert a direct voltage into an alternating voltage.

In the example according to FIG. 7, an electronic switch 9 is assigned to each electric phase A1 to A18, selectively alternating between a positive or negative direct voltage +, −, of the free end of the respective conductor portion 3, of a direct voltage supply designed as a direct voltage (DC) bus 12.

FIG. 8 shows the exemplary structure of the switch 9 according to FIG. 7. Said switch is formed as a bipolar electronic power switch component.

In place of the bipolar switch 9, a unipolar switch 10 may be used as exemplified in FIG. 10. The unipolar switch 10 connects in each case one end of a conductor portion A1 to A18 with a unipolar direct voltage +. In this case, the short-circuit ring 4 is connected to the negative pole of said voltage source. The number of power switches can be halved in this embodiment according to FIGS. 9 and 10, which significantly reduces the total costs.

FIG. 11 shows a development of FIG. 7. Here, multiple DC voltage sources 11 are provided, which are each connected to the direct voltage bus 12 in a parallel circuit.

As an alternative, merely one single direct voltage source may be used instead of multiple direct voltage sources 11.

FIG. 12 shows a modification of the principle of FIG. 11 in an example, in which a common DC bus 12 is not provided, but separated conductor portions 13, 14 respectively, which supply current to multiple switches for the phases A1 to A4 respectively A5 to A8 etc. of the conductor portions. Here, each direct voltage portion 13, 14 is assigned one direct voltage source 11.

FIG. 13 shows an alternative embodiment of the power supply unit with a rotating brush system. Said direct voltage supply system replaces the above described alternating current supplies of FIGS. 7 to 12 of the power supply unit.

The power supply unit, according to FIG. 13, equipped with a direct voltage source comprises winding commutators 15, rotating carbon brushes 16 and direct voltage supply commutators 17, 18. The conductor portions 3 are connected on the second side of the stator with one winding commutator 15 in each case. The number of winding commutators 15 in this example is equal to the number of conductor portions 15 and thus the stator slots.

As shown in FIG. 14A, the ends of the conductor portions 3 may as well serve as winding commutators 15.

The connections +, − of a direct voltage source 11, illustrated here, are connected to the direct voltage supply commutators 17, 18. Here, the positive direct voltage terminal is connected to the commutator 17 and the negative direct voltage terminal of the same voltage source is connected to the commutator 18. Rotating carbon brushes 16 are arranged between the winding commutators and the direct voltage supply commutators, which guide the current from the direct voltage supply source to the conductor portions 3. The carbon brushes can be driven by another electric machine or be directly connected to the rotor shaft of the electric machine so that they are directly moved by a distinct machine rotor. The rotational speed of the carbon brushes depends on the desired rotational speed of the magnetic field of the machine.

As shown in an example in FIG. 13, a first group of conductor portions is supplied with the positive direct voltage, while the opposite group of conductor portions, which is offset by 180°, is supplied with negative direct voltage. Furthermore, the carbon brushes 16 are rotated as explained above. The magnetic field, which is generated in the machine, rotates at the same speed as the brush system. In other words, a rotating magnetic field is generated in the machine, although the machine is supplied with DC currents.

FIG. 14B shows the rotating carbon brush ring 16 and a corresponding direct voltage supply commutator 17 as an example for utilization with the stator winding according to FIG. 14A, with the free ends of conductor portions 3 formed as winding commutators 15.

FIGS. 15A to 15C show, as a further example, two rotating carbon brush rings 16 with direct voltage supply commutators 17, 18, according to FIG. 15A, the arrangement of the rotating carbon brush rings on the stator winding according to FIG. 15B and the entire stator with the winding system and the carbon brush rings according to FIG. 15C.

FIG. 16 shows, by means of a graph, a comparison of the magnetomotive force plotted against the electrical angle in each case, once with a solid line for the direct voltage supply and with a dashed line for the alternating voltage supply.

FIG. 17 shows, by means of a graph, the dispersal of the harmonics of the magnetomotive force in one comparison, with black balks for the direct voltage supply and white balks for the alternating voltage supply.

The embodiment with power switches according to FIGS. 7 to 12 is thus understood as an alternating voltage supply, whereas the principle with rotating brushes according to FIGS. 13 to 15C is understood as a direct voltage supply.

One recognizes that the suggested DC supply comprises a better distribution of the components of the magnetomotive force and moreover a somewhat higher power density than the AC supply. The comparison happens in the same electrical conditions, in each case.

FIGS. 18A and 18B show in each case perspective views of an embodiment of the proposed electric machine. The stator winding comprises 36 conductor portions 3, which are inserted into respective slots of the stator 1.

On the first side 5 of the stator illustrated in FIG. 18B, a short-circuit ring 4 is provided, which short-circuits the 36 conductor portions 3 with one another on this side of the stator.

FIG. 18A shows the free ends of the conductor portions 3 on the second side 6 of the stator, which are connected with a power supply unit not illustrated here. The power supply unit may comprise, for example, one of the above illustrated direct or alternating voltage supplies.

FIG. 19A shows the stator winding of the embodiment from FIGS. 18A and 18B.

As illustrated in FIG. 19B, each conductor portion 3 is formed as a solid, cuboid and straight conductor portion, which extends mainly in the axial direction of the machine. It is quickly evident that the production of such a stator winding is possible with little effort.

Instead of the embodiment as a solid cuboid conductor portion according to FIG. 19B, the conductor portions 3′ can also be formed as a so-called stranded conductor, whereby possible skin effects and proximity effects could be markedly reduced. Such a conductor portion 3′, which is formed as a stranded conductor, is shown in FIG. 19C. All or a selection of the conductor portion of the stator winding may be formed in such a manner.

Instead of the shown cuboid designs in FIGS. 19B and 19C, the conductor portions may comprise rounded corners and/or rounded edges. When exactly one conductor portion is inserted into each slot, the slot fill factor is measurably higher than for the commonly distributed windings. This leads to a lower phase resistance. Therefore, aluminum material may be readily used instead of copper for the conductor portions. Hereby weight and cost will be further reduced.

FIGS. 20A to 20D show different embodiments of the conductor portions 3, respectively, in a sectional view of the stator 1.

A conventional cuboid conductor portion is shown in FIG. 20A.

FIG. 20B shows an alternative embodiment, in which instead of a single solid cuboid conductor of FIG. 20A, three parallel connected, also cuboid conductor sub-portions are provided in each case, which, for example as shown in FIG. 20B, may comprise a an almost square cross-section.

The sum of the cross-sections of the conductor sub-portions 19 of FIG. 10B corresponds to the cross-section of the conductor portion 3 of FIG. 20A.

A reduction of skin effect and proximity effect is attainable through this distribution, similar like for the measures according to FIG. 19C.

When iron bridges 20 are provided between the conductor sub-portions 19, the slot leakage inductance can be further increased. The inductance of the phase winding is also increased thereby. The iron bridges 20 connect neighboring stator teeth, respectively between the parallel conductor sub-portions 19, in the circumferential direction. This embodiment is shown in FIG. 20C.

The conductor portion 3 can completely fill the slot in an embodiment, as shown in FIG. 20D. Hereby the slot fill factor can be increased to 100%. Together with the one sided short-circuit ring, this winding may be produced with a (high) pressure casting method, for example, further reducing the production costs of the machine.

FIG. 21 shows an embodiment of a proposed electric machine with one stator 1, which is designed to receive a stator winding with 100 phases and thus 100 stator slots. The machine is designed as a four-pole electric machine. The more phases or stator slots, respectively, the machine comprises, the better the magnetomotive force plotted against the circumferential angle approximates an ideal sinusoidal form.

Another advantage of a very high number of phases is that the phase current decreases as the number of winding phases increases. When the phase current is low, cost-efficient standard power switch components may be used for the realization of an alternating voltage supply.

Another advantage of a very high number of phases is that the phase inductance also decreases. The proposed structure of the stator winding comprises a winding number of 1 per phase. This yields a low self-inductance. Because the phase inductance corresponds to the sum of the self-inductance and counter-inductance, phase inductance may be increased via an increase in counter-inductance, according to the following formula:

$${L}_{phase} = {L}_{A} \cdot ( 1 + {\sum }_{k = 1}^{m - 1} {cos}^{2} ( k \frac{2 π}{m} ) )$$

L_{A} is the amplitude of the self-inductance.

FIG. 22A shows a further embodiment of the proposed electric machine, in which based on FIG. 21 the number of phases was increased high enough that no teeth remain between the conductor portions 3 anymore. Neither stator teeth nor slots are therefore provided. In other words, the stator winding in this machine is provided in the air gap between the stator and the rotor.

This will be quite apparent with the help of a detailed enlargement of an exemplary sector according to FIG. 22B. Because the winding and securing material of the conductor portions on the stator are not magnetic, the effective air gap of such machines without teeth and slots is very large. On the other hand, the cross-section of the single conductor portions is reduced by a repeated increase in the number of stator phases, leading to a further reduction of the skin effect and proximity effect. Moreover, an almost sinusoidal course of the magnetomotive force across the circumferential angle on the one hand and on the other hand further reduced phase currents are attainable by the repeated increase of the number of phases. This results in low resistive machine losses, a very simple construction of the machine and, based on the low currents, a small power electronics. The structure of the machine without slots or teeth is so simple, because the stator 1 is merely cylindrical and comprises a stator winding on the inside, which corresponds to a cage winding, in which a short-circuit ring is provided only on one side, however.

The proposed electric machine is applicable for a plurality of different electric machine types. Said electric machine comprises radial flux machines, axial flux machines, linear machines. All of these machines can work as synchronous and asynchronous machines. The radial flux machine can be constructed with an inner rotor or an outer rotor. Moreover, all of the above mentioned machine types may be combined with different rotor topologies.

FIGS. 23 to 26 show exemplary rotors, which are applicable according to the proposed principle. So FIG. 23 shows a permanent magnet rotor, FIG. 24 shows a reluctance rotor, FIG. 25 shows a current excited rotor and FIG. 26 shows an asynchronous rotor.

These rotors are not explained more in detail at this point, since it is concerning rotors of electric machines that are known per se.

FIG. 27 shows an alternative embodiment of the stator winding, according to the proposed principle. In all previous exemplary embodiments, merely one short-circuit ring 4 is provided on the first side of the stator. However, for all multiphase machines with a pole pair number larger than 1, it is possible to define two groups of conductor portions, from which the conductor portions of the first group are short-circuited with one another on a first side 5 of the stator and the conductor portions of a second group are short-circuited with one another on an opposite second side 6 of the stator. For this purpose, corresponding short-circuit rings 4, 22 may be provided in each case.

On the left half of the diagram of FIG. 27, the conductor portions A1 to A18 with the short-circuit ring 5 are short-circuited with one another on the first side 5 of the stator. These conductor portions are assigned a first pole pair. The conductor portions of a second pole pair, which are illustrated on the right half of FIG. 27, are connected with one another via a short-circuit ring 22, however, on the opposite second side 6 of the stator. For both groups of the conductor portions, it is true that these are connected on the respective free sides to a current supply unit. Said unit may comprise bipolar switching means, as is shown in FIGS. 7 and 8, which place a positive or negative direct current voltage on the respective free end of the corresponding conductor portions.

For all exemplary embodiments shown in FIGS. 1 to 27, it is true that there is a plurality of possible operational modes. So the number of pole pairs may be changed in the asynchronous machine, for example, even during operation.

The number of active phases can also be changed, even during operation.

The active switching phases can be distributed symmetrically or asymmetrically around the machine circumference. Independent from the working point, the type of operation of the machine may be changed in order to achieve improved efficiency.

It is also possible, for example, to adapt the operational parameter, according to the demand, depending on if the highest possible performance or the longest possible service life of the machine is desired.

FIG. 28 shows a first exemplary embodiment of a short-circuit ring 41 with cooling fins 51. Based on the short-circuit ring from FIG. 2 having the conductor portions 3 connected thereto, the short-circuit ring 41 is provided with radial inwardly running cooling fins 51 on the inner radius of said ring. The cooling fins 51 end flush respectively with the short-circuit ring 41 in the axial direction in this example. Here the cooling fins have a flat, cuboid geometry and are spaced apart from each other in the circumferential direction.

FIG. 29 shows the exemplary embodiment from FIG. 28 with stator 1. The conductor sections 3 are inserted into the respective slots of the stator 1.

FIG. 30 shows a second exemplary embodiment of a short-circuit ring 42 with cooling fins 52. Based on the short-circuit ring from FIG. 2 having the conductor portions 3 connected thereto, the short-circuit ring 42 is provided with radial outwardly running cooling fins 52 on the outer radius of said ring.

FIG. 31 shows the exemplary embodiment from FIG. 30 with stator 1. The conductor sections 3 are inserted into respective slots of the stator 1. The cooling fins 52 terminate with the outer diameter of the stator 1 in the radial outward direction. Here, the cooling fins have a flat, cuboid geometry and are spaced apart from one another in the circumferential direction.

FIG. 32 shows a third exemplary embodiment of a short-circuit ring 43 with cooling fins. Based on the short-circuit ring from FIG. 2 having the conductor portions 3 connected thereto, the short-circuit ring 4 is provided with axial running cooling fins 53 on its face side facing away from conductor portions 3, which extend from the face side of the short-circuit ring 43. Here the cooling fins have a flat, cuboid geometry and are spaced apart from one another in the circumferential direction. The conductor portions 3 are inserted into the respective slots of the stator 1.

FIG. 33 shows a fourth exemplary embodiment of a short-circuit ring 44 with cooling fins. Based on the short-circuit ring from FIG. 2, in the short-circuit ring 44 the radial outwardly pointing cooling fins 52 of the embodiment of FIGS. 30, 31 are combined with the axially arranged cooling fins 53 of the embodiment of FIG. 32. Reference is made to the avoidance of repetition of the description there.

The cooling fins serve to improve heat dissipation, respectively.

### LIST OF REFERENCE NUMERALS

1 stator
2 slot
3 conductor portion
3′ stranded conductor
4 short-circuit ring
5 first side
6 second side
7 power source
8 power supply unit
9 switch
10 switch
11 direct voltage source
12 direct voltage bus
13 direct voltage bus
14 direct voltage bus
15 commutator
16 carbon brush
17 commutator
18 commutator
19 conductor sub-part
20 iron bridge
21 rotor
22 short circuit ring
41 short circuit ring
42 short circuit ring
43 short circuit ring
44 short-circuit ring
51 cooling fins
52 cooling fins
53 cooling fins
A1 to A18: phases of the conductor portions

1. An electric machine with a stator and a rotor mounted movable relative to said stator, wherein:
the stator comprises a plurality of slots for receiving a stator winding,
exactly one conductor portion of the stator winding is inserted per slot,
the conductor portions on a first side of the stator are short-circuited with one another in a short-circuiting element, wherein the short-circuiting element and the conductor portions are integrally formed,
the conductor portions on a second side of the stator opposite the first side are each connected to a terminal of a power supply unit.

2. The electric machine according to claim 1,
in which the conductor portions, which are short-circuited with one another on the first side of the stator, are assigned to a first pole pair, and in which further conductor portions are provided in further slots of the stator, which are assigned to another pole pair, which are short-circuited with one another on the second side of the stator and each conductor portion on the respective non-short-circuited side is connected to a terminal of the power supply unit.

3. The electric machine according to claim 1 or 2,
in which the conductor portions, either individually or in groups of commonly controlled and neighboring conductor portions, are supplied with a distinct electric phase by the power supply unit, wherein the groups of commonly controlled, neighboring conductor portions each comprise 2 or more conductor portions.

4. The electric machine according to claim 1 or 2, in which the number of phases is at least 3.

5. The electric machine according to claim 1 or 2, in which the number of phases is at least 4.

6. The electric machine according to claim 1 or 2, in which the number of phases is at least 5.

7. The electric machine according to claim 1 or 2, in which the number of phases is at least 10.

8. The electric machine according to claim 1 or 2, in which the conductor portions inserted into the slots are straight.

9. The electric machine according to claim 1 or 2, in which the conductor portions inserted in the slots comprise aluminum rods, copper rods and bronze rods.

10. The electric machine according to claim 1 or 2, in which a short-circuit ring is provided for short-circuiting the conductor portions.

11. The electric machine according to claim 1 or 2,
in which the power supply unit is set-up to change the pole pair number during operation of the machine.

12. The electric machine according to claim 1 or 2,
in which the power supply unit is set-up to deactivate at least one conductor portion during operation.

13. The electric machine according to claim 1 or 2,
in which the power supply unit comprises commutation elements in order to generate various electric phases and supply them to the conductor portions of the stator.

14. The electric machine according to claim 1 or 2,
in which the conductor portions inserted into the slots comprise at least two conductor sub-portions connected in parallel.

15. The electric machine according to claim 14,
in which iron bridges are formed between the conductor sub-portions which are connected in parallel.

16. The electric machine according to claim 1 or 2,
in which the power supply unit comprises one or multiple direct voltage sources, which are connected to the conductor portions via electric switches.

17. The electric machine according to claim 1 or 2,
in which the short-circuiting element comprises cooling fins.
